(19) United States
(12) Patent Application Publication
(10) Pub. No.: US 2013/0192106 A1
(43) Pub. Date: Aug. 1, 2013

(54) Method and Apparatus for Displaying and Selling Products

(71) Applicant: McNeil-PPC, Inc., Skillman, NJ (US)

(72) Inventors: Charles Meyer-Hanover, Summit, NJ (US); Steven J. Hecht, Wyckoff, NJ (US)

(73) Assignee: McNeil-PPC, Inc., Skillman, NJ (US)

(21) Appl. No.: 13/776,150

(22) Filed: Feb. 25, 2013

Related U.S. Application Data
(63) Continuation of application No. 12/546,997, filed on Aug. 25, 2009, now abandoned.

(51) Int. Cl. A47F 5/00; G09F 3/00

(52) U.S. Cl. CPC A47F 5/00; G09F 3/00
USPC 40/299.01; 211/49.1

(57) ABSTRACT

A method and apparatus for displaying and selling products from different product segments within a planogram for products of only one product segment. A product display interrupter is provided in a product display of products from a single product segment to interrupt the display to draw the consumer's attention to another product not of that product segment. The product display interrupter may be in the form of a stand-alone display structure. Preferably, the products to be displayed are framed by and within the product display interrupter. Indicia, such as information on how the products are to be used in conjunction with one another, may be provided on the product display interrupter.

### CROSS-REFERENCE TO RELATED APPLICATION

This application is a Continuation of and claims the benefit of the earlier filing date of U.S. patent application Ser. No. 12/546,997, filed Aug. 25, 2009, which also claims the benefit of the earlier filing date of U.S. provisional patent application No. 61/091,526, filed Aug. 25, 2008, which application is hereby incorporated by reference herein in its entirety.

### FIELD OF THE INVENTION

The present invention relates to a method and apparatus for displaying products in a retail store. The present invention further relates to a method and apparatus for modifying consumer purchasing habits.

### BACKGROUND OF THE INVENTION

Retail stores generally group their goods by product category. For instance, in the case of retail stores for consumer goods, such as a drug store, different consumer goods are generally grouped according to the product category in which they belong, such product categories including, without limitation, oral care products, wound care products, hair care products, baby products, makeup, cleaning products, paper goods, over-the-counter medicines, and the like. Similarly, in supermarkets different groceries or consumer package goods are generally grouped according to the product category in which they belong, such product categories including, without limitation, cereals, beverages, dairy, meat, frozen foods, snacks, breads, baking items, paper goods, baby products, pet food and pet care items, pharmacy goods, canned goods, and the like. Even “superstores” and warehouse club stores that sell a wide range of products (such as pharmacy items, food items, clothes, cleansers, toys, movies, electronics, paper goods, stationery supplies, cleaning supplies, etc.) are generally arranged by product category.

Within each product category may be a further segregation of products by product segment. For instance, in the oral care product category, the toothpaste, mouthwash, dental floss, and toothbrush product segments are generally grouped separately from one another. Similarly, in the wound care product category, cleansers, wound treatments (such as topical antibiotics), and bandages are generally grouped separately from one another. Food product segments in food product categories are likewise segregated. For instance, cooked cereals, dry cereals, and breakfast bars are arranged apart from one another in separate product segments in the cereal category. Similar principles are applied to other retail products or items. Each product segment grouping may contain a variety of different products or SKU's (stock keeping units), from the same or different manufacturers. The different products in a given segment may vary by any of a variety of features that products in such product segment may have (e.g., flavor, fragrance, color, ingredients, additives, size, brand, material, etc.). The packaging of the different products in a given product segment need not be the same. For instance, some product segments contain similar products that may be packaged in various manners, such as bottles, canisters, boxes (which may or may not be a secondary package containing a bottle therein as the primary package for the product), bags, or blister cards. Such packaging generally has a particular manner in which it is most preferably displayed. For instance, bottles and boxes can be placed directly on a shelf or in a pusher tray. Blister cards typically are hung from pegs projecting from peg boards positioned at the back of the display.

There are various theories of organizing products in retail stores. Such organization ranges from placement of entire product categories (relative to other product categories, or relative to the layout of the store, such as location relative to the entrance/exit) to placement of product segments within a given product category. Retailers may utilize a planogram (also known as plano-grams, plan-o-grams, schematics (archaic) or POGs)—a type of visual diagram or drawing or schematic specific to the retail industry—to plan where every product in the retail store should be placed. For instance, it may be desirable to organize products according to a particular category segmentation and/or product purchase behavior of the consumer, and/or according to price point options, and/or to increase visibility of the product. Planograms can be used not only to present a flow chart for the various product categories within the store layout, but also to show particular relative placement of product segments in an aisle for a given product category, and even to show the particular arrangement of the various products in a given product segment in the store fixture (the structure that holds and displays the majority of the store's merchandise, such as a gondola, coffin, or freezer case). For instance, the planogram may be used to illustrate how and where retail products should be displayed, such as the location along a store aisle, the level along the fixture's height at which a SKU should be placed, how many facings (amount of shelf space) should be allocated for that SKU, the arrangement of different but related SKU's relative to one another, etc. Judicious use of planograms thus may be used to increase product visibility and/or customer purchases. The rules and theories for the creation of a planogram may be set based on discussions, negotiations, and/or sharing of shopper insights and shopper behavior.

Despite retailer efforts to organize product categories and segments and/or to influence consumer buying behaviors through the use of planograms, the number of products in many or most retail stores still may be overwhelming After having been presented with so many choices within a given segment of a product category, a consumer may not then turn to the other segments in that product category to be presented with even more products to choose from. Consumers intending to purchase a particular product may be so overwhelmed by the variety and number of products in the product segment of that particular product that purchase of products from other segments in that category may be overlooked and/or forgotten. Even if a product in one category is to be used in conjunction with a product in the same category, such related products may not be situated closely enough to each other to promote sale of both (or, the sale of one in connection with the other), and thus one of the related products may be overlooked by the consumer. Such is particularly the case with cross-merchandised products that may be used in conjunction with one another, such as to improve product specific benefits, but which belong in different product segments or even in different product categories altogether. And, in mass merchandiser stores within a supercenter format (a large square-foot store which sells both food and general non-food merchandise, from drugs to personal care items to clothes to sporting goods to home and garden equipment), product category aisles may be so long (as long as 40 to 60 feet) that segments are spaced far apart enough from one another that a consumer does not even notice the other segment when purchasing a product from the targeted segment (the segment from which the consumer initially planned to purchase). This is particularly the case when a consumer has entered the category aisle with the intention of purchasing a product from only one product segment. A growing consumer desire for a quick shopping experience further contributes to missed retailer opportunities to sell products.

Market research on consumer shopping behavior has confirmed that consumers may see products from only one segment and bypass products from other related segments. Consumers may forget to buy the product from the related segment. Or, the consumer may not even be aware of the full benefits of use of the product from the related segment with the product the consumer intends to purchase. Often, decisions to purchase a particular product the consumer did not originally intend to purchase are made because the consumer sees that other product or is otherwise made aware of that product. If the consumer's attention is not drawn to more than one product segment, the consumer may limit his purchase to only the product he initially intended to purchase, and may not consider purchase of a product from a related segment.

In order to draw the consumer's attention to another product related to the product initially intended to be purchased (such as a related product that may be used in conjunction with the product the consumer initially intended to purchase), various displays and fittings have been designed. For instance, end caps and side kicks are used at the ends of aisles to promote the sale of products, and may be used to promote the sale of products from different segments of the same product category together with one another. Or, free-standing displays may be provided in a product segment to display products from a different segment. For instance, clip strips or shelf extenders have been provided on shelves to augment the product segment display to include and to promote purchase of products from other related segments. Such solutions as end caps and side kicks generally are temporary, since both are temporary fixtures that the retailer typically rotates or replaces with other end caps and side kicks several times in a month. Temporary displays can detract from the appearance of the product segment display because they tend to quickly wear out and have to be discarded. Retailers therefore may not be inclined to use such temporary displays. Moreover, temporary displays generally are not usually re-stocked and therefore are discarded, or are not readily re-stocked and therefore require added retailer labor, increasing the retailer's reluctance to use such displays.

### SUMMARY OF THE INVENTION

The present invention relates to modification of the manner in which products are displayed for purchase. The present invention also relates to the modification of consumer shopping behavior, which may be achieved through modification of the manner in which products are displayed for purchase. The principles of the present invention may be applied to educate consumers regarding use of a first product in conjunction with one or more other products different from the first product, thereby influencing shopper behavior.

In accordance with principles of the present invention, a display structure is provided within the planogram of a selected product segment to remain within that planogram until the planogram is reset. The display structure therefore is preferably formed to be relatively durable and thus at least semi-permanent. The display structure may be self-standing and/or may provide product supporting elements so that the display structure is readily integrated into the planogram of a selected product segment while being capable of displaying products not generally displayed in such product segment or planogram. For instance, a frame element interrupting the planogram to display different products not generally displayed in such planogram may be provided with its own peg board for supporting such different products.

These and other features and advantages of the present invention will be readily apparent from the following detailed description of the invention, the scope of the invention being set out in the appended claims.

### BRIEF DESCRIPTION OF THE DRAWING

The detailed description will be better understood in conjunction with the accompanying drawings, wherein like reference characters represent like elements, as follows:

FIG. 1 is a perspective view of an exemplary product display interrupting structure placed on an exemplary product display shelf;

FIG. 2 is a perspective view of another exemplary product display interrupting structure placed on an exemplary product display shelf;

FIG. 3 is a perspective view of an exemplary product display interrupting structure in isolation;

FIG. 4 is a front elevational view of the exemplary product display interrupting structure of FIG. 3; and

FIG. 5 is a side elevational view of the exemplary product display interrupting structure of FIG. 3.

### DETAILED DESCRIPTION OF THE INVENTION

Many or even most retailers organize their stores by grouping merchandise by product category, by grouping products in each category by product segment, and by grouping the different products in each product segment by brand or feature or benefit or other scheme. Such grouping is generally based on the consumer shopping behavior measured by a consumer decision hierarchy study, and is typically called “planogramming” the display. Each product typically has a primary selling location or home location in the retail store (hereinafter “home retail position” for the sake of convenience without any intent to limit) at which the product is essentially permanently located and displayed for purchase. In the merchandising industry, “permanently located” is understood as the location set by the store for a given product, such as in a planogram, for a relatively extended time period, such as for at least 3-6 months or 6-12 months, most typically for a minimum of 6 months. Consumers generally expect to find a given product at its home retail position and head to such permanent location when shopping for such item. In contrast, products are located at promotional locations for shorter periods of time to catch the consumer's attention and to encourage impulse purchases. For instance, end caps, side kicks, clip strips, shelf extenders, cardboard shelf displays, and the like are used to display products on a rotating or semi-permanent basis, such as for a promotional time period generally not lasting more than one week or one month.

When a consumer enters a store to purchase one or more particular items, the consumer generally heads to the particular store aisles designated for such items. For the sake of convenience, without intent to limit, such as to facilitate describing the present invention and distinguishing the present invention over the prior art, a given product for which a consumer enters a given store with general intent to purchase (and which product may be the primary or even sole motivation to go to and/or to enter the store in the first place) is referenced herein as the “intended purchase item.” In such cases, the consumer often heads straight to the home retail position for the intended purchase item, bypassing other aisles. More particularly, the consumer often heads straight to the section of the aisle designated for the intended purchase item (such aisle section hereinafter referenced as the “destination segment” for the sake of convenience, without any intent to limit) without paying any attention to the other product segments in the aisle, even if such product segments contain products that may or even should be used with the intended purchase item. If the aisle is particularly long and/or certain segments are not in the visual vicinity of the destination segment, the consumer, when approaching the destination or leaving the aisle to resume shopping in other parts of the store, may not even pass other product segments.

One or more various products of another segment or even another product category may be used in conjunction with the consumer's intended purchase item. For the sake of convenience, without any intent to limit, such other products are referenced hereinafter as “associated items” or “items associated with the intended purchase item.” For purposes of the present invention, “in conjunction with” includes simultaneous or sequential use, whether or not the products are combined together or maintained apart. Also for the sake of convenience, and without any intent to limit, in the context of being displayed in the destination segment or their home retail position, the intended purchase item(s) may also be referenced as “primary product(s).” Because, as discussed above, consumer shopping habits may tend to allow the consumer to bypass the home retail position of the items associated with the consumer's intended purchase item, the consumer may not remember, or even think of purchasing the associated items. Even if a promotional display is situated in a more prominent area that ought to be passed by the consumer en route to the intended purchase item, if the promotional display does not catch the consumer's attention, then the consumer may completely bypass associated items.

One object of the present invention is to modify consumer purchasing behavior by drawing the consumer's attention to a product different from the consumer's intended purchase item while the consumer is selecting the intended purchase item. In accordance with the principles of the present invention, modification of consumer purchasing behavior may be achieved by interrupting a product display in the home retail position of the intended purchase item and displaying a different product, such as an associated product. Such interruption of the product display attracts the consumer's attention to the different product to permit the consumer to consider purchase of such different product. It will be appreciated that although the different product preferably is associated with the intended purchase item, the principles of the present invention may be applied more broadly to other types of products not considered when purchasing the intended purchase item and not necessarily used in conjunction with the intended purchase item, such as totally unrelated products.

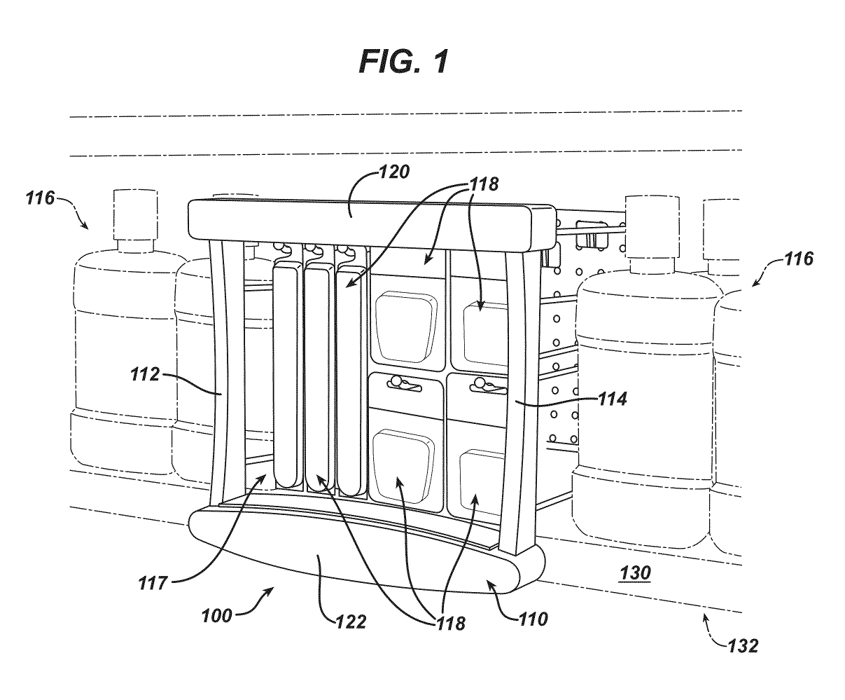

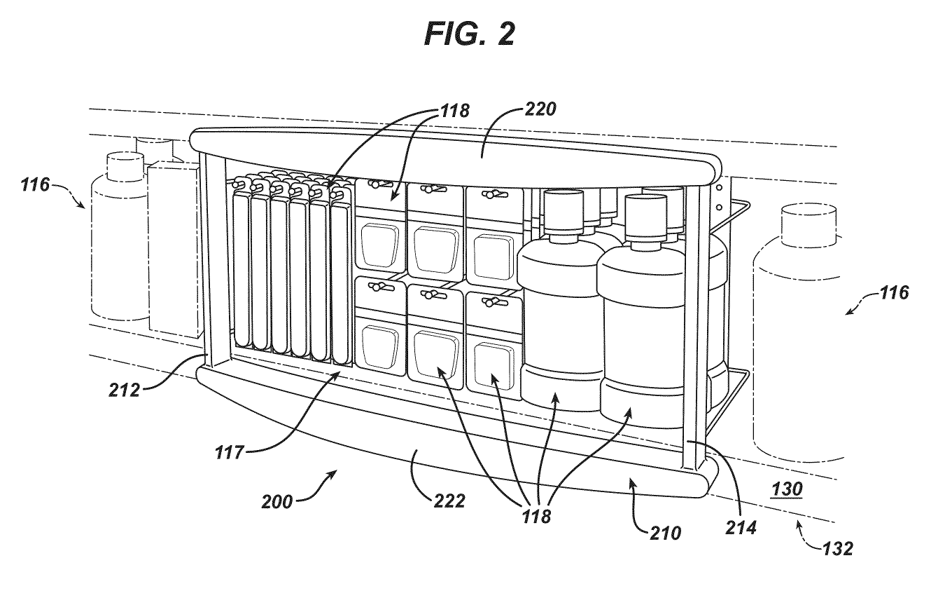

As illustrated in FIGS. 1 and 2, interruption of a product display for a given product segment may be achieved by a product display interrupter 100, 200 that physically interrupts the continuity of a display or arrangement of a primary product in its home retail position and sets off or delineates an area within the display for displaying a different product not belonging in such retail position. Exemplary product display interrupter 100 of FIG. 1 has a frame element 110 having at least display interrupting sides 112, 114 (individually, left side 112 and right side 114) that interrupt display of primary products 116 (the products whose home retail position is the display section in which product display interrupter 100, 200 is placed) on either side of product display interrupter 100 and create an interrupted space or display area 117 between primary products 116 for display of different products 118 (hereinafter “interrupting products 118” for the sake of convenience) in such space. Preferably, display interrupting sides 112, 114 interrupt the display of the primary products 116 sufficiently to attract consumer attention to the interrupting products 118 displayed in interrupted display area 117 within frame element 110. Although not critical to the function of separating primary products 116 from interrupting products 118, frame element 100 may also include a top side 120 (which may also be referenced as a header) and a bottom side 122 (which may also be referenced as a base), which may be used to enhance the framing and differentiating of interrupting products 118 in interrupted display area 117. Product display interrupter 200 has features similar to those of product display interrupter 100, referenced with the same reference numerals increased by 100. Specifically, product display interrupter 200, like product display interrupter 100, has a frame element 210 having interrupting sides 212, 214 defining an interrupted space 217 therein, and may also include a header 220 and a base 222.

In accordance with one aspect of the present invention, product display interrupter 100, 200 is configured to be integrated (preferably visually) within a planogram of a given product segment so that the display within product display interrupter 100, 200 substantially blends with the display of products surrounding product display interrupter 100, 200. As such, frame element 220 sets apart a display of interrupting products 118 that would not otherwise be visually distinct from the surrounding display of primary products 116 (other than by virtue of interrupting products 118 not belonging to the product segment in which primary products 116 belong). For instance, interrupting products 118 may be arranged within product display interrupter 100, 200 in a manner typically used to display such products so that the display of products within product display interrupter 100, 200 is typical of or analogous to the display of such products at their home retail position. In other words, interrupting products 118 may be displayed in a manner that is substantially the same as the manner in which such products are displayed in their home retail position, allowing for variations such as may be required by the requirements of the display area of the primary products 116. Additionally, or alternatively, interrupting products 118 may be arranged within a product display interrupter 100, 200 positioned within a planogram for different primary products 116 in a manner that is not substantially different from, and instead blends in with and is in a similar style as, the manner in which the surrounding primary products 116 are displayed. Additionally, or alternatively, interrupting products 118 may be faced within product display interrupter 100, 200 to be aligned with the facings of the primary products 116 surrounding product display interrupter 100, 200. In this context, “facing” (also known as fronting, straightening) is used in terms of the act of pulling each product to the front edge of a shelf with the label turned forward, such as to give the store an appearance of being full with merchandise, and “faced” refers to result of such facing.

The mere physical presence of product display interrupters 100, 200 in the display area for a given product segment (intended to contain products from only that product segment) calls out an interruption in the product display that preferably is greater than the discontinuity and/or contrast that would be achieved by simply placing a selected product outside its own home retail position and in the home retail position of a different product segment or category. Such interruption of the display of primary products in their home retail position through the use of product display interrupters 100, 200 of the present invention to display different products along with the primary products interrupts the consumer's shopping expectations and/or attracts the consumer's attention to the different product for purchase consideration. Any part of product display interrupter 100, 200, such as part or all of frame element 110, 210, may be configured to enhance the function of product display interrupter 100, 200 as drawing the consumer's attention to products within interrupted display area 117, 217. For instance, frame element 110, 210 may have a distinct, preferably attention-grabbing, shape, color (such as a bright and/or bold color(s) or a color(s) contrasting with the color(s) of the primary products 116 on display), or material (such as a shiny or light reflective material,) or other eye-catching visuals, or a cost-saving/price discounting communication (e.g., a coupon dispenser). If desired, any section of frame element 110, 210, or all of frame element 110, 210, may be made more attention-grabbing such as by being provided with one or more sensory cues besides a simple visual cue. For instance, frame element 110, 210 may bear lighted elements (e.g., LED's, light bulbs, reflective elements, etc.), sound-making elements (e.g., electronic chips making music, such as the jingle for a product, or making statements about the product, or providing other information), or spring-loaded moving images, etc. If desired, frame element 110, 210 may be positioned to extend beyond front edge 130 of shelf 132. Such extension of frame element 110, 210 beyond shelf front edge 130 need only be sufficient to attract the consumer's attention while passing shelf 132.

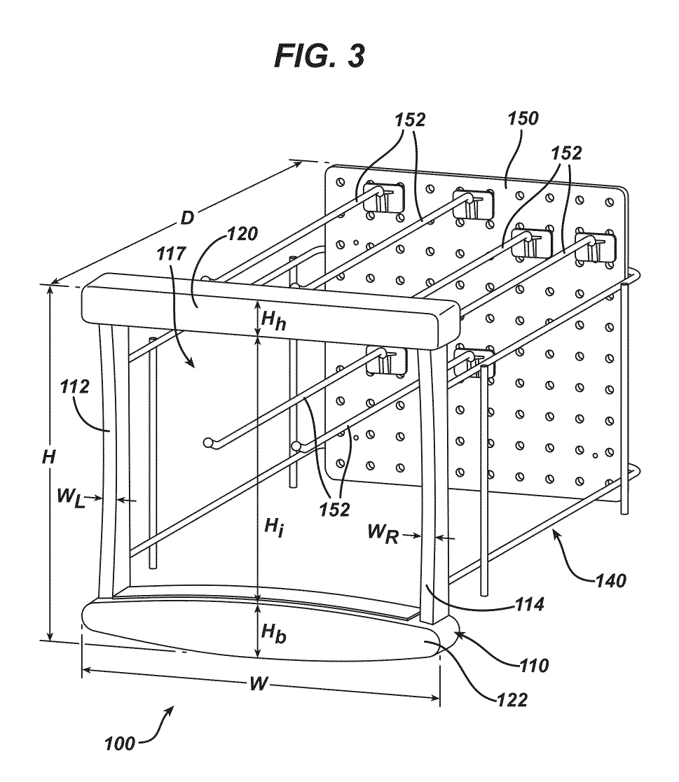

Because retailers do not want interruption of a home retail position to reduce generally limited display space (e.g., limited shelf space on a gondola), it is desirable for the widths W_{L}, W_{R} (see, for example, FIG. 3) of respective left and right interrupter sides 112, 212, 114, 214 to be as narrow as possible while still serving the desired display interrupting function. Header 120, 220 and base 122, 222 of frame element 110, 210 may therefore also be configured to enhance the function of product display interrupter 100, 200 as described above with respect to interrupter sides 112, 212, 114, and 214. Another or additional use of header 120, 220 and base 122, 222 of frame element 110, 210 is to display indicia, such as tag lines, logos, or other branding. More than one type of indicia may be provided. For instance, logos may be provided on one or more segments of frame element 110, 210 along with tag lines or other information on the same or different elements of frame element 110, 210. Additionally, or alternatively, header 120, 220 and base 122, 222 may be used as information bars providing information about the primary product 116 and/or the interrupting product(s) 118 such as an announcement (stating that the product is “new,” “improved,” has special benefits, etc.), or other information that may serve to educate and/or inform the consumer. For instance, the information may concern the connection between primary product 116 and interrupting product(s) 118. Product display interrupter 100, 200 may additionally or alternatively provide information through provision of coupons, tear pads, brochures, or other additional materials coupled to and/or supported by product display interrupter 100, 200.

In accordance with principles of the present invention, product display interrupter 100, 200 may be used not only to interrupt display of primary product 116 to display a different, interrupting product or products 118, and not only to provide information about primary product 116 and/or interrupting product(s) 118, but may also be used to educate consumers about methods of using the primary and /or interrupting product(s). One particularly beneficial use of header 120, 220 and/or base 122, 222 of frame element 110, 210 of product display interrupter 100, 200 is as an education or therapeutic menu bar bearing information for educating consumers about use of interrupting product(s) 118 in conjunction with primary product 116 (the intended purchase product). In such case, interrupting product(s) 118 may include one or more products that may be used in conjunction with the intended purchase product and thus may also be referenced as “associated products.” At least one, if not all, such associated products may be provided in interrupted display area 117 as interrupting products 118 to facilitate the consumer's purchase of such item. Thus, not only is the consumer's attention being drawn to a product different from the intended purchase item, but the consumer is also being informed of the benefits of purchasing such different item so that the consumer is even more inclined to purchase the different item in addition to the intended purchase item. As may be appreciated, such education of the consumer may increase potential of impulse and/or informed purchasing, and preferably even future purchase, of the interrupting products displayed within interrupted display area 117 of product display interrupter 100, 200.

As discussed above, one form of consumer education that may be provided by product display interrupter 100, 200 may pertain to the use of associated products that may be used in conjunction with the intended purchase item. For instance, information may be provided on product display interrupter 100, 200 pertaining to items that can or even should be used together with the intended purchase item. More particularly, such use can be in accordance with a prescribed regimen that may enhance or improve use of the intended purchase item and/or add to the overall health of the consumer. It will be appreciated, particularly from a retailer and manufacturer's perspective, such information may create a more loyalized user of the category and increase the sales for the retailer. Exemplary regimens that may be presented by a product display interrupter 100, 200 in accordance with the principles of the present invention include oral care regimens (such as Johnson & Johnson's BRUSH, FLOSS & RINSE™ regimen of brushing teeth, then flossing, then rinsing with mouthwash such as Listerine® mouthwash sold by the Johnson & Johnson Healthcare Products Division of McNeil-PPC, Inc.), wound care regimens (such as the “clean, treat, protect” regimen, propounded by Johnson & Johnson Consumer Companies, Inc, of cleaning a wound, treating the wound such as with a topical antibiotic, and protecting the wound such as with an adhesive bandage), skin treatments (such as the use of make-up removers, skin cleansers, exfoliation products or devices, and moisturizers as a skin care regimen), and the like. The provision of an element such as product display interrupter 100, 200 to educate consumers therefore improves the consumer's use of the intended purchase item, and increases purchase volume of different items or products which may not even have been purchased had the consumer not been educated, at the primary location, as to the benefits of use of such associated products in conjunction with the intended purchase item or even without the intended purchase item. A consumer that did not realize such different item or product is beneficial to use with the intended purchase item may not have intended to buy such different item or product but for product display interrupter 100, 200. Or, a consumer that had forgotten to purchase such different item or product as interrupting product(s) 118, or even had no intention of buying such different item or product as interrupting product(s) 118 would be more likely to purchase such product thanks to the interruption and educational information provided by product display interrupter 100.

It is appreciated that temporary displays, such as end caps or side caps, may be used as educational displays in accordance with the principles of the present invention. Nonetheless, the use of a product display interrupter 100, 200 formed in accordance with the principles of the present invention has the added benefit of interrupting the continuity of the arrangement or display of the intended purchase item in the home retail position for such item. Consumers who head straight to the destination segment or home retail position of their intended purchase item therefore are more likely to be affected by the educational information provided by the present invention than by a temporary display that may not be noticed, and may even be ignored, by a busy shopper not having time for casual browsing in the store. The educational elements of the product display interrupter associated with products on a shelf within the aisle may alter the behavior of the shopper more then those located at the traditional promotional locations in store which are outside of the aisle and generally will only attract a limited number of impulse buyers and not current category buyers. Having the educational information on product display interrupter 100, 200 in the aisle where the consumer has stopped to shop the category has more impact, because they are currently involved in buying the category. Moreover, product display interrupter 100, 200 may be configured as the home retail position for the interrupting products 118 to be displayed therein. Provision of interrupting products 118 only at product display interrupter 100, 200 (and not within their own home retail position) may serve to increase the incremental nature of interrupting products 118, may allow for in-store efficiency (one item at one location eliminates the need to be sure the item is re-stocked in more than one location), and facilitates tracking of sales of interrupting products 118 from product display interrupter 100, 200.

To enhance one or more of the benefits of a product display interrupter 100, 200 formed in accordance with one or more principles of the present invention described above, product display interrupter 100, 200 may be formed as a semi-permanent fixture that may be placed within the home retail position of a selected product segment to which the interrupting product(s) 118 does not belong. A “semi-permanent” fixture is to be understood within the context of the present invention as meaning a fixture that does not wear away readily and can withstand wear through a typical planogram cycle of a store (typically at least 6 months, and generally approximately 6-12 months), as contrasted with cardboard display structures, such as typical PDQ displays (quickly assembled, typically temporary promotional, displays) or other temporary displays used in end caps, or stand alone temporary promotional displays. Product display interrupter 100, 200 thus preferably may be formed or substantially formed from one or more relatively rigid materials, such as metal and/or plastic and/or wood (plywood, particle board, and the like) and/or glass and/or acrylic (e.g., Plexiglas®). Such rigid material may be the same as or similar to the materials used for the display at the home retail position of the intended purchase item, and/or the display of the interrupting products, with the added benefit of better integration of product display interrupter 100, 200 with the primary product display area in the home retail position. Also, a product display interrupter 100, 200 formed in accordance with the principles of the present invention to be semi-permanent permits a longer opportunity for interrupting products 118 displayed in interrupted display area 117 to be on the shelf to be shopped with the primary products 116 on the shelf.

As may be appreciated, a display structure formed in accordance with the principles of the present invention permits modification of a primary product display to contain within such display products not belonging in such display, such as products from a product segment different from the product segment in which the inventive display structure is placed. It is appreciated that most retailers want to maintain separation between the product segments of a product category. Therefore, the principles of the present invention may be applied by determining the product segments most often visited by consumers and modifying the displays in such product segment to contain one or more products of another segment or even another product category.

Although one aspect of the present invention focuses on consumer behavior, another aspect of the present invention addresses retailer needs and behavior. In particular, in accordance with another separate aspect of the present invention (which may or may not be implemented with the aspect of the present invention addressing the modification of consumer behavior), the present invention may meet the needs and/or behaviors of retailers such as by providing ease of positioning the display structure at its intended location and/or ease of re-stocking. Construction of product display interrupter 100, 200 from materials which are the same as or similar to those of the display for the primary product or for the interrupting product when displayed in its home retail location, as discussed above, provides aesthetic benefits to the retailer by permitting, at least to some extent, visual integration of the display structures. Product display interrupter 100, 200 may be formed so that it is a part of the planogram for the product segment in which it is placed (such product segment preferably being different from the product segment of the interrupting products 118 displayed by product display interrupter 100, 200), and remains in the home retail position of primary product 116 (which is different from the home retail position of interrupting product 118) as long as the products displayed therein are selling or until the planogram is reset. As such, product display interrupter 100, 200 may be said to be positioned “within” the planogram for the product segment of primary product 116, and/or “fully integrated” into the home retail position of primary product 116 to display interrupting products 118 belonging to a different product segment or product category than that of the home retail position in which product display interrupter 100, 200 is located.

As discussed above, integration of product display interrupter 100, 200 within the primary product display may further involve displaying interrupting products 118 within interrupted display area 117 in a manner as in the home retail position of such interrupting products 118. For instance, product display interrupter 100, 200 may be formed to interrupt display of primary products 116 without modifying the manner of displaying primary products 116 or interrupting products 118, such as by utilizing the same manner of displaying interrupting products 118 as would be used when interrupting products 118 are displayed in their own home retail positions.

Integration that maintains similar display elements as used at the home retail position for the interrupting products 118 to be displayed within interrupted display area 117 of product display interrupter 100, 200 also facilitates ease of use by the retailer. The act of stocking of an item outside its home retail position (in a different product segment) need not involve any change in retailer behavior other than modifying the location at which stocking occurs. Thus, the employee stocking a particular item simply need continue the same physical actions (such as laying products on a shelf, or hanging products from pegs protruding from a peg board backing) at a different location.

Product display interrupter 100, 200 may additionally or alternatively be formed to facilitate facing (pulling products to the front of product display interrupter 100, 200 to create the look of a perfectly stocked and/or neat and/or organized display). For instance, if pegs are provided in product display interrupter 100, 200, such pegs may be provided to extended the entire depth of product display interrupter 100, 200 so that upon facing product display interrupter 100, 200, interrupting products 118 within interrupted display area 117 are positioned generally in-line with frame element 110, 210 and not protruding or substantially protruding beyond frame element 110, 210, or too far behind frame element 110, 210 and/or front edge 130 of the shelf 132 on which product display interrupter 100, 200 is placed. It will be appreciated that product display interrupter 100, 200 need not have a depth that extends the full depth of the display in which product display interrupter 100, 200 is positioned.

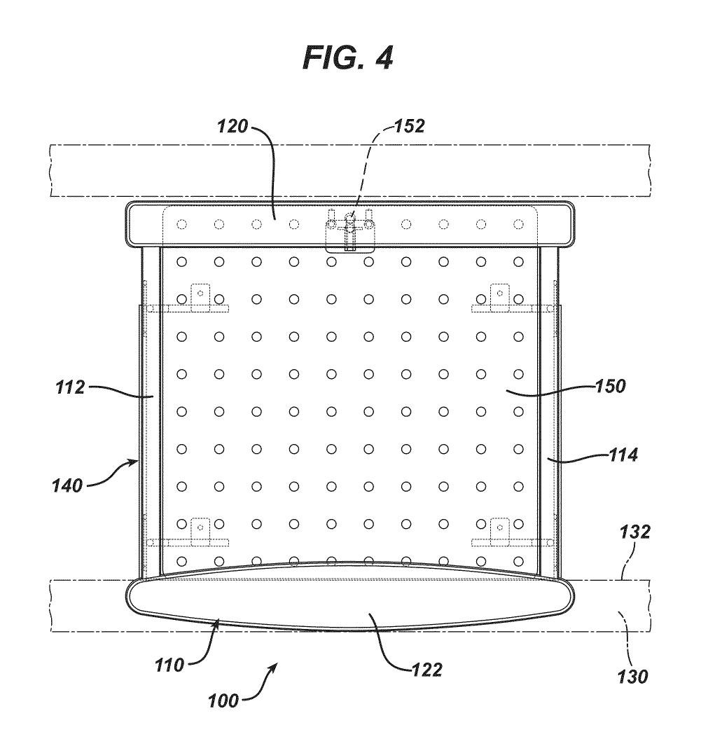

An exemplary product display interrupter 100 formed in accordance with one or more of the above-described principles of the present inventions is illustrated in isolation (i.e., not in its integrated position within the product display or planogram of primary products 116) in FIGS. 3, 4, and 5. It will be appreciated that width W of product display interrupter 100 may be determined based on the size and/or number of interrupting products 118 to be displayed within interrupted display area 117. Alternative exemplary product display interrupter 200 of FIG. 2 may have substantially the same features as product display interrupter 200, with a width W sized to include a larger variety or quantity of interrupting products 118, or even to include within interrupted display area 117 at least one facing of primary products 116.

As may be appreciated with reference to FIGS. 3, 4, and 5, exemplary product display interrupter 100 may be formed as a substantially self-standing structure that can be readily inserted on a displaying element of a fixture, such as a shelf on a gondola fixture. However, other structures incorporating features of product display interrupter 100, 200 may be formed for use with other types of store fixtures to achieve one or more objects of the present invention. In accordance with at least one of the principles of the present invention discussed above, product display interrupter 100 may be constructed for ready assembly, insertion into a display area, and removal by the retailer. Product display interrupter 100, 200 preferably is easy for retailers to use despite the modification of the interrupting product 118 stocking location required by the present invention.

To facilitate the preferable self-standing nature of exemplary product display interrupter 100, a frame supporting structure 140 is provided, preferably coupled to frame element 110. As illustrated in FIGS. 3, 4, and 5, frame supporting structure 140 may be in the form of an open support structure. An open support structure has several benefits, such as being lightweight (and therefore readily shipped, carried, and manipulated), and relatively inexpensive (because of the use of less material). For instance, an open wire structure may be used, such structure being relatively lightweight and inexpensive to manufacture, yet relatively sturdy (such as compared to cardboard structures). Frame supporting structure 140 may be coupled to frame element 110 in any desired manner which preferably is sufficiently secure to last through the life of product display interrupter 100, such as welding, gluing, screwing, nailing, etc.

In accordance with another aspect of the present invention that need not be applied in conjunction with other features described herein, product display interrupter 100 may be formed with its own product supporting element 150. Preferably, product supporting element 150 is the same type of supporting element used to support interrupting products 118 in their home retail location. For instance, if interrupting products 118 are hung from pegs at their home retail location, than product supporting element 150 may be a peg board with pegs 152 permitting arrangements that may be altered as desired. A product display interrupter 100 so formed is thus not only self-standing, but also a self-contained display unit. In other words, a product display interrupter 100 with its own product supporting element 150, as in FIGS. 3, 4, and 5 can be used in a fixture having product display elements intended for primary products only, and not intended to display the interrupting products to be displayed in product display interrupter 100. Of course, it will be appreciated that if interrupting products 118 are typically laid directly on a support structure of a display fixture (such as a shelf on a gondola fixture), then supporting element 150 would be the support structure on which product display interrupter 100 is supported.

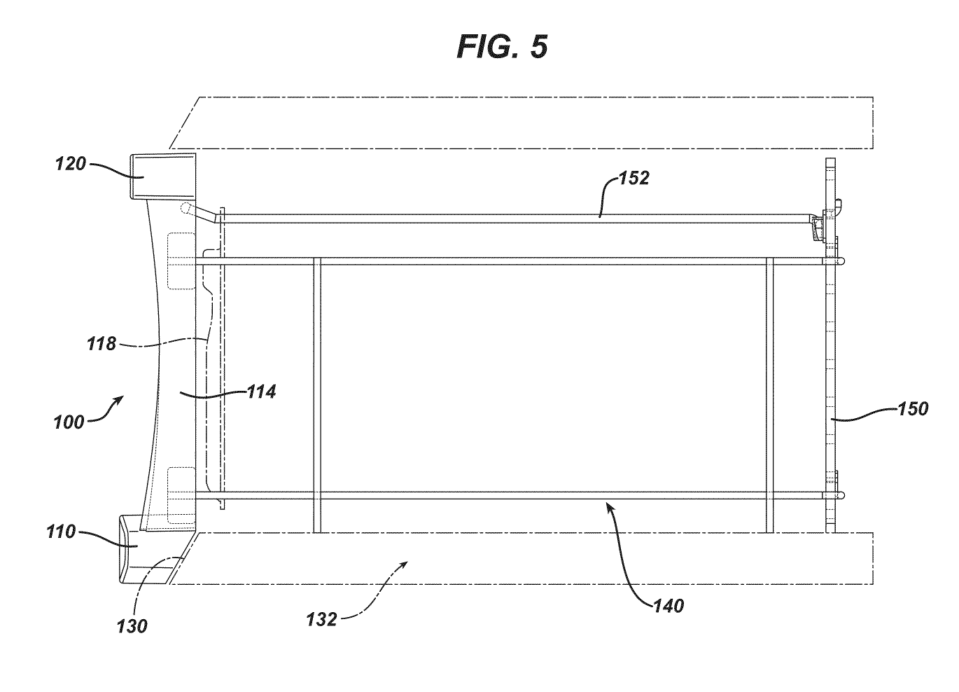

In accordance with yet another aspect of the present invention that need not be applied in conjunction with other features described herein, if a product supporting element 150 in the form of a peg board is provided, pegs 152 may be provided in lengths long enough to extend the full depth D of product display interrupter 100. As illustrated in FIG. 5, pegs 152 extend substantially the full depth D of product display interrupter 100 from product supporting element 150 to frame element 110 so that interrupting products 118 may be fully faced on shelf 132, at front edge 130, and positioned within (as opposed to behind) frame element 110. In order to fully “face” the items in product display interrupter 100, pegs 152 should be sufficiently long to reach from the back to the front of product display interrupter 100. If standard pegs were used, the item/products/SKU's held thereon would not be as readily seen within frame element 110 of product display interrupter 100 even when they are fully “faced” on the standard pegs. It is desirable for products to extend sufficiently forward so that frame element 110 and the shelf above product display interrupter 100 do not block the product from being seen by consumers while they are shopping. It will be appreciated that product display interrupter 100, 200 need not extend the full depth of the display in which it is positioned. For instance, the distance from product supporting element 150 to frame element 110 of product display interrupter 100, 200 may be less than the depth of a shelf on which product display interrupter 100, 200 is provided and primary products 116 are displayed. It will also be appreciated that facing may be relative to (to be in-line with) primary product 160 rather than to frame element 110.

It will be appreciated that the precise shape and arrangement of display interrupting sides 112, 114, header 120, and base 122 of frame element 110 may be varied from the exemplary ones illustrated in FIGS. 3, 4, and 5. For instance, header height Hₕ of header 120 and base height Hₕ of base 122 are selected for the embodiment of FIGS. 3, 4, and 5 to provide sufficient space to serve as an education or therapeutic menu bar and thus to provide sufficient area for relevant product information. However, if indicia requiring less space are provided instead, then header 120 and base 122 may be sized smaller. The same applies to the sizing of side elements 112, 114.

Another consideration in forming frame element 110 may be to assure that products may be readily inserted into interrupted display area 117 for stocking and re-stocking, and may be readily accessed and removed therefrom by a consumer for purchase.

In general, the size and shape and configuration of frame element 110 may be selected to facilitate stocking/re-stocking of products within product display interrupter 100 by the retailer as well as removal of products from product display interrupter 100 by consumers. Preferably, frame element 110 is configured so that the sellable area in interrupted display area 117 therein is not blocked. Preferably, the top of base 122 does not extend so far above the top 134 of a shelf 130 on which product display interrupter 100 is positioned such that products displayed in interrupted display area 117 cannot readily and easily be stocked/re-stocked therein or removed therefrom. Similarly, the bottom of header 120 preferably does not extend so far into interrupted display area 117 to impede stocking/re-stocking or removal of products from product display interrupter 100.

It will be appreciated that features described with respect to one embodiment typically may be applied to another embodiment, whether or not explicitly indicated. The various features hereinafter described may be used singly or in any combination thereof. Therefore, the present invention is not limited to only the embodiments specifically described herein and is not limited to require all or even more than one of the inventive features.

While the foregoing description and drawings represent exemplary embodiments of the present invention, it will be understood that various additions, modifications and substitutions may be made therein without departing from the spirit and scope of the present invention. In particular, it will be clear to those skilled in the art that the present invention may be embodied in other specific forms, structures, arrangements, proportions, and with other elements, materials, and components, and otherwise without departing from the spirit or scope of the present invention. One skilled in the art will appreciate that the invention may be used with many modifications of structure, arrangement, proportions, materials, and components and otherwise, used in the practice of the invention, which are particularly adapted to specific environments and operative requirements without departing from the principles of the present invention. For example, elements may be integrally formed or may be constructed of multiple parts, the operation of elements may be reversed or otherwise varied, the size or dimensions of the elements may be varied. The presently disclosed embodiments are therefore to be considered in all respects as illustrative and not restrictive, the scope of the invention being indicated by the appended claims, and not limited to the foregoing description.

1.-10. (canceled)

11. A method of displaying secondary products in a retail store planogram for primary products in a product category, wherein primary products, all belonging to only one product segment are planogrammed to be displayed areas separate from secondary products belonging to a second product segment, said method comprising:
interrupting a display of primary products in a first planogrammed area of a first product segment to which said primary products belong with a product display interrupter to create an interrupted display area within said first planogrammed area; and
displaying in the interrupted display area interrupting products of a second product segment different from said first product segment in a manner analogous to the manner in which the interrupting products are displayed in their home retail position
wherein said product display interrupter comprises
a frame element defining the interrupted display area within which secondary products are displayed within said planogram for primary products; and
a frame support element supporting said frame element as a self-standing unit formed independently of and supported by the display structure supporting the primary products.

12. A method as in claim 11, further comprising displaying said interrupting products within said frame element in the same manner in which said interrupting products are displayed in their home retail position.

13. A method as in claim 12, further comprising providing indicia on said frame element.

14. A method as in claim 13, wherein said indicia are selected from the group consisting of: brand identifying indicia, information relevant to the use of said first and second products, tag lines, and colors.

15. A method as in claim 11, further comprising visually integrating said product display interrupter into the planogram of said first product segment.

16. A method as in claim 11, further comprising facing the primary products and the interrupting products to be aligned with one another.

17. A method as in claim 11, further comprising displaying at least one product from the first product segment within the product display interrupter.

18. A method of modifying consumer purchasing behavior, said method comprising:
interrupting a display of primary products in a first planogrammed area of a first product segment with a product display interrupter having a frame element creating an interrupted display area and supported by a frame support element such that the product display interrupter is formed independently of yet supported by the product displaying element supporting the primary products;
displaying an interrupting product of a second product segment within the interrupted display area; and
providing the frame element with indicia relevant to at least one of the primary products and the interrupting product.

19. A method as in claim 18, wherein said indicia are selected from the group consisting of: brand identifying indicia, information relevant to the use of said first and second products, tag lines, and colors.

20. A method as in claim 18, further comprising visually integrating the product display interrupter into the planogram of the first product segment.

21. (canceled)

22. A method as in claim 11, wherein the second product segment is in the same product category as the first product segment.

23. A method as in claim 12, wherein the product display interrupter further comprises a peg board with pegs for supporting the interrupting products, said method further comprising displaying the interrupting products by hanging the interrupting products from the pegs supported by the peg board.

24. A method as in claim 13, wherein the indicia are product-related indicia related to the product category of the planogram in which the product display interrupter is provided.

25. A method as in claim 18, wherein the product display interrupter further comprises a peg board with pegs for supporting the interrupting products, said method further comprising displaying the interrupting products by hanging the interrupting products from the pegs supported by the peg board.
